(19) United States
(12) Patent Application Publication
(10) Pub. No.: US 2026/0302752 A1
(43) Pub. Date: Oct. 1, 2026

(54) Cable Conduit

(71) Applicant: D-Line (Europe) Limited, North Shields Tyne and Wear (GB)

(72) Inventors: Paul Ruddick, North Shields Tyne and Wear (GB); Stephen Bianchi, North Shields Tyne and Wear (GB)

(21) Appl. No.: 19/480,993

(22) PCT Filed: Apr. 19, 2024
(86) PCT No.: PCT/EP2024/060777

§ 371 Date: Nov. 3, 2025

(30) Foreign Application Priority Data
May 4, 2023 (GB) 2306618.6

(51) Int. Cl. H02G 9/04

(52) U.S. Cl. CPC H02G 9/04

(57) ABSTRACT

A cable conduit is provided for resting upon a surface and housing a cable. The conduit has a longitudinal axis defining a centreline of the conduit and a cable containment channel extending along the longitudinal axis for housing the cable. The conduit comprises: a base portion, a first ramp portion, and a second ramp portion. The base portion extends between a first longitudinal edge and a second longitudinal edge and comprises a first planar section extending between the first longitudinal edge and the centreline, and a second planar section extending between the second longitudinal edge and the centreline. The first ramp portion extends from the first longitudinal edge of the base portion towards the centreline thereby defining a first angle between the first section of the base portion and the first ramp portion. The second ramp portion extends from the second longitudinal edge of the base portion towards the centreline thereby defining a second angle between the second section of the base portion and the second ramp portion. An inner edge of the first ramp portion and an inner edge of the second ramp portion are separated by a longitudinal opening. The longitudinal opening extends parallel to the centreline and exposes the cable containment channel. The first angle and the second angle are each less than 15 degrees, and the base portion is configured to deform about the centreline, such that the conduit is invertible between: a first configuration and a second configuration. In the first configuration, the first section and the second section of the base portion are co-planar and the longitudinal opening has a first width. In the second configuration the first ramp portion and the second ramp portion are co-planar and the longitudinal opening has a second width. The second width is narrower than the first width.

### FIELD OF THE INVENTION

The present invention relates to a cable conduit for resting on a surface and housing a cable.

### BACKGROUND

People who own electric vehicles (EV) but do not have access to a private driveway or a garage may wish to charge their electric vehicle on a roadside outside of their residence. In this situation an EV charging cable may be laid across a public pavement or walkway to connect the electric vehicle to a charging station. In some cases, the EV charging cable may be fed from a charging post or similar whereby the EV charging cable must be run along the length of a street or path.

In such cases, an EV charging cable lying upon the pavement is a trip hazard to pedestrians and can inconvenience wheelchair users who are using the pavement. Additionally, the EV charging cable may be damaged by vehicles, bicycles, or mobility scooters etc running over it.

Cable conduits for resting upon pavements or other surfaces are generally known. Such conduits may comprise rigid or semi-rigid materials for placing on top of cables to prevent people from tripping over the cables. Such conduits may be referred to as surface or above-pavement conduits, channels or ducts.

Typically, known conduits are placed over the top of a cable and comprise an inclined surface (i.e., a slope or ramp) on either side of the cable. Known conduits typically have ramps which are inclined at angles between 25 to 30 degrees relative to the surface the conduit rests on. Therefore, these conduits are generally narrow, prone to displacement if knocked or kicked, and have relatively steep gradients which can still present a trip hazard. Additionally, these steep conduits are inconvenient for e.g., wheelchair users and cyclists who wish to roll over the conduit.

In addition, it can be awkward and time consuming to install and remove EV cables from such conduits because the entire conduit must be lifted away from the pavement to access the EV cable underneath. Therefore, these conduits often can't be permanently installed on a pavement because they must be removed each time the cable is accessed.

Other known surface conduits are narrow strips but have an open topped channel that acts as a cavity for encasing the cable. If the cable(s) is removed, or does not fill the cavity when encased, then the open top can present a safety hazard to cyclists or pedestrians wearing heeled footwear for example.

Alternative surface conduits may comprise a lid which extends along the length of conduit and is configured to close over the cable. Cables may be installed and removed from above the conduit through an upper opening which is closed by the lid. However, when the lid is closed, the cable must enter the channel at one end of the channel and exit the channel at a second, opposite end. However, if the electric vehicle is parked partially over the pavement and the conduit, then the second end of the conduit may be blocked by the vehicle thereby making it difficult to connect the cable to the vehicle. In this example, the cable may exit the conduit part way along the conduit between the two ends. However, the lid would need to be opened and would be unable to close while there is a protruding cable thus presenting a trip hazard and impeding wheelchair users.

Accordingly, there is a desire for an improved above-pavement conduit for protecting EV charging cables which is more user-friendly, more versatile by offering topside-up or base-up configurations and which can be less hazardous to users of the pavement. The present invention has been devised in light of the above considerations.

### SUMMARY OF THE INVENTION

Broadly speaking the present invention aims to address the problems of existing above-pavement cable conduits with the provision of a shallow gradient conduit which does not include a lid but instead includes a narrow opening for inserting cables. Additionally, the shallow conduit is uniquely reversible by having the central material acting as a hinge thus enabling the conduit to be used in “topside-up” or a “base-up” configuration according to user preference.

The invention includes the combination of the aspects and preferred features described except where such a combination is clearly impermissible or expressly avoided.

Accordingly, a first aspect of the present invention provides a cable conduit configured to rest on a surface and house a cable, the conduit having a longitudinal axis defining a centreline of the conduit and a cable containment channel extending along the longitudinal axis for housing the cable, wherein the conduit comprises:
a base portion extending between a first longitudinal edge and a second longitudinal edge, the base portion comprising a first planar section extending between the first longitudinal edge and the centreline, and a second planar section extending between the second longitudinal edge and the centreline;
a first ramp portion extending from the first longitudinal edge of the base portion towards the centreline thereby defining a first angle between the first planar section of the base portion and the first ramp portion; and
a second ramp portion extending from the second longitudinal edge of the base portion towards the centreline thereby defining a second angle between the second planar section of the base portion and the second ramp portion,
wherein:
   an inner edge of the first ramp portion and an inner edge of the second ramp portion are separated by a longitudinal opening, the longitudinal opening extending parallel to the centreline and exposing the cable containment channel;
   the first angle and the second angle are each less than 15 degrees, and the base portion is configured to deform about the centreline, such that the conduit is invertible between:
      a first configuration wherein the first section and the second section of the base portion are co-planar and the longitudinal opening has a first width, and
      a second configuration wherein the first ramp portion and the second ramp portion are co-planar and the longitudinal opening has a second width, the second width being narrower than the first width.

The first and second angles being less than 15 degrees means that the cable conduit is shallower than typical conduits. Additionally, the shallow gradient of the ramp portions (owing to the first and second angles being less than 15 degrees) results in a conduit that may be wider than other known conduits ensuring that the conduit of the first aspect is less prone to displacement if it is knocked or kicked. Therefore, the conduit is safer and less inconvenient for people moving over it.

Additionally, the conduit being deformable about the centreline means that the conduit is reversible (i.e., the conduit may be used in an “inverted configuration”). Accordingly, the conduit is more adaptable for different applications, surfaces, and user preference. For example the conduit may be used with different types of cables such as EV charging cables or other, non-EV cables, which may have smaller diameters than typical EV charging cables.

For example, in the first configuration, the first and second sections of the base portion being coplanar usefully enables the conduit to lie flat on a planar surface, on the base portion of the conduit. Therefore, the first configuration may be referred to as a “topside-up configuration” wherein the conduit may be placed on the surface with the base portion being proximal to the surface and the longitudinal opening being distal to the surface.

In the second configuration, the first and second ramp portions being coplanar usefully enables the conduit to lie flat on a planar surface, on the first and second ramp portions of the conduit. Therefore, the second configuration may be referred to as a “base-up configuration” or an “inverted configuration” wherein the conduit may be placed on a surface with the longitudinal opening being proximal to the surface and the base portion being distal to the surface.

Therefore, the conduit has improved stability when it is placed on a surface in both configurations compared to existing conduits which do not deform in this way and are prone to rocking motions when they are using in inverted configurations.

When the conduit is in the first configuration (i.e., the top-side up configuration) the longitudinal opening may be exposed and available for installing and removing the cable from a standing position which can be more user-friendly. Therefore, conduits according to the first aspect of the invention enable quick and convenient access to the cable containment channel inside by virtue of the opening between the inner edges. Additionally, the opening between the inner edges of the ramp portions enables the EV cable to exit the conduit partway along the conduit without a trip hazard being created by any raised lid section.

Alternatively, when the conduit is in the second configuration the conduit may be placed over the top of the cable thereby providing improved protection for the cable from objects moving over the cable or from the weather.

The first and second angles may be the same in the first and second configurations. Therefore, the advantageous shallow incline and decline of the conduit may be observed in both configurations.

The conduit may be suitable for e.g., EV cables, other cables, or hose pipes. In some examples, the cable containment channel may be configured to house more than one cable. For example, the cable containment channel may have an inner diameter which is larger than the diameter of a typical EV cable. In some examples, the cable containment channel may comprise multiple compartments for housing a cable.

The first configuration may be referred to as a top-up configuration when the conduit is resting on a surface, wherein the base portion is proximal to the surface and the longitudinal opening is distal to the surface. Accordingly, in the first configuration the longitudinal opening may be referred to as the top of the conduit or as an upper opening. As discussed above, the deformation of the base portion about the centreline therefore enables the base portion to lie flush with the surface in the top-up configuration.

When the conduit is in the top-up configuration, (first configuration) and resting upon a planar surface, the first and second sections of the base portion may be configured to rest on the surface and the first and second ramp portions may extend away from the surface, at the first and second angles respectively, towards the longitudinal opening

The second configuration may be referred to as a base-up or inverted configuration when the conduit is resting on the surface, wherein the longitudinal opening is proximal to the surface and the base portion is distal to the surface. Therefore, in the second configuration the first and second sections of the base portion may be considered as upper portions of the conduit which are joined along the centreline and configured to cover the cable.

The longitudinal opening may be configured to have the first width when the conduit is in the top-up configuration and a second width when the conduit is in the base-up configuration, wherein the second width is narrower than the first width.

The surface may be a pavement. For example, the pavement may be a sidewalk, a footpath, a private or public car park, garage forecourt, transport yard or a walkway for pedestrians which is located adjacent to a road or a street. The pavement may be located between a charging station and charging point for charging an electric vehicle. The charging point may be located in a road where the electric vehicle is parked. However, the cable conduit may be used on any suitable surface between a charging station and a charging point. For example, the cable conduit may be installed on the surface of a road or a private driveway or a public EV-charging station.

The ramp portions may be planar. For example, the first ramp portion, or an outer surface of the first ramp portion, may lie along a first flat plane. The first flat plane may be inclined relative to the first section of the base portion at the first angle. Likewise, the second ramp portion, or an outer surface of the second ramp portion, may lie along a second flat plane. The second flat plane may be inclined relative to the first section of the base portion at the second angle.

In some examples, as discussed below, an outer surface of the first and/or second ramp portions may have surface decoration such as a rough or corrugated surface. However, the overall shape of the ramp portions may be planar and thus lie along the first and second planes, respectively.

The base portion of the conduit may be a lowermost section of the conduit which is configured to rest on the pavement when the conduit is in the first (topside-up configuration). Therefore, the base portion may be a planar surface extending in the longitudinal direction when the conduit is in the first configuration. When the conduit is placed on a planar surface in the first configuration, with the base portion being proximal to the surface and the longitudinal opening distal to the surface (i.e., topside-up), the angles between the first and second ramp portions and the planar surface may be the first and second angles respectively.

The base portion may be rectangular, the longitudinal edges of the rectangle being parallel to the longitudinal axis. In some examples, as discussed below, the base portion may include grooves, screw holes, and/or corrugations.

The base portion may be integral. For example, the first and second sections of the base portion may be integrally formed from one component and configured to deform about the centreline.

When the conduit is in the second configuration, the first and second ramp portions may be configured to rest on the surface. The base portion may be configured to deform about the centreline such that the first and second sections of the base portion form additional ramp portions extending away from the surface when the conduit is in the second configuration. Therefore, when the conduit is placed on a planar surface in the second configuration, with the base portion being distal to the surface and the longitudinal opening being proximal the surface, the angles between the first and second sections of the base portion and the planar surface may be the first and second angles, respectively.

The first and second inner edges of the first and second ramp portions may be longitudinally extending edges of the first and second ramp portions which are distal to the longitudinal edges of the base portion. In some examples, as described below, when the first and/or second ramp portions comprise inwardly extending lips, the first and/or second inner edges may be the inner edges of the inwardly extending lips.

The longitudinal opening may be considered as a gap or space between the inner edges of the first and second ram portions. Therefore the longitudinal opening may also be referred to as a separation distance between the first inner edge and the second inner edge. Accordingly, the skilled person would understand that the first and second widths of the opening may have a distance which is non-zero. In other words, when the conduit is in the first and second configurations, the first inner edge and the second inner edge do not touch and are separated by the longitudinal opening.

The longitudinal opening may be configured to receive a cable therethrough. Therefore, when the conduit is placed on the surface, with the longitudinal opening distal to the surface (i.e., in the topside-up configuration), a cable may be installed through the longitudinal opening. The cable may also exit the conduit part-way along the longitudinal opening and be optionally gripped by the inner edges of the first and second ramp portions.

Providing an opening between the first and second inner edges which has a non-zero width can reduce stresses which are applied to the first and second inner edges when cables are inserted into and removed from the conduit. For example, if the first and second inner edges of the sidewalls (or inner lips of the first and second sidewalls as described below) were configured to close completely over the cable containment channel, then a cable being inserted into the conduit could drag the first and second inner edges inside the conduit thereby distorting the conduit. Over time the conduit could be permanently distorted. Therefore, by providing an opening between the first and second inner edges when the conduit is in the first configuration, the likelihood of the conduit being permanently distorted is reduced.

The longitudinal opening may extend along the entirety of the length of the conduit. However, in some examples, the longitudinal opening may extend partially along the length of the conduit in the longitudinal direction. For example, the opening may be interrupted by supporting structures which connect the first and second inner edges.

The width of the longitudinal opening, in the first and/or second configurations, may be a distance between the inner edges of the first and second ramp portions measured in a direction perpendicular, or transverse, to the longitudinal direction. The first and second inner edges may be uniform along the longitudinal direction such that the width of the longitudinal opening is constant along the length of the conduit in the longitudinal direction. However, in some examples the first and/or second inner edges may be non-uniform in the longitudinal direction such that the width of the longitudinal opening varies along the length of the conduit in the longitudinal direction. Therefore in this example, the second width of the opening as measured at a first location along the longitudinal axis may be narrower than the first width of the opening as measured at the same location along the longitudinal axis.

The conduit may extend from a first end opening at one end of the conduit to a second end opening at an opposite end of the conduit. The longitudinal axis may dissect the conduit from the first end opening to the second end opening. In other words the longitudinal axis may be parallel to the direction from the first opening to the second opening (or vice versa). The conduit may be an elongate conduit extending form the first end to the second end. However, in some examples the conduit may be cut to a length wherein the width of the base portion is longer that the distance between the first end and the second end.

The first end opening, which may be referred to as the cable entrance, may be positioned closer to a charging station and the second end opening, which may be referred to as the cable exit, may be located closer to a kerbside or to a charging point for charging an electric vehicle. However, in some examples, an EV charging cable may enter and/or exit the conduit part-way along the length of the conduit via the longitudinal opening between the first and second inner edges when the conduit is in the first (topside-up configuration). Of course, when the conduit is not placed on a surface of a pavement, both of the first or second end openings may be considered as the cable entrance or exit.

The centreline of the conduit may be an axis which is parallel to the longitudinal axis and extends along a deformation axis of the base portion. The deformation axis of the base portion may be an axis about which the base portion is configured to bends or deform when the conduit is moved between the first and second configurations. In some examples, the centreline of the conduit may extend along a halfway point between the first and second longitudinal edges of the base portion.

The deformation of the base portion about the centreline may result in a pivoting, hinging or folding motion of the base portion. For example, the first and second sections of the base portions are configured to pivot towards and away from each other. For example, the conduit may begin in the first configuration wherein the first and second base portions are coplanar and the width of the longitudinal opening between the first and second ramp portions is the first width. Next, the first and second ramp portions may be pivoted about the centreline towards the second configuration wherein the first and second ramp portions are coplanar, thus narrowing the longitudinal opening between the first and second ramp portions until the width of the opening is the second width. Meanwhile, the base portion may bend along the centreline, thereby enabling the pivoting of the ramp portions, and the first and second sections of the base portion about the centreline towards each other.

In some examples, the conduit may be configured to deform beyond the first and/or second configurations. In the following examples, an upwards direction may be defined as a direction from the base portion towards the longitudinal opening and a downward direction may be defined as a direction from the longitudinal opening towards the base portion.

The base portion may be configured to deform along the centreline such that the first and second sections of the base portion (and the first and second ramp portions) pivot about the centreline in the upwards direction towards the second configuration. The conduit may be configured to deform further than the second configuration such that the width of the longitudinal opening is narrower than the second width and an upper angle between the first and second ramp portions is less than 180°. In some examples, the base portion of the conduit may be configured to deform to an additional configuration where in the first and second inner edges of the ramp portions touch each other (i.e., the conduit may be configured to deform beyond the second configuration to a configuration wherein the longitudinal opening has a width of zero.)

In other examples, the base portion may be configured to deform along the centreline such that the first and second sections of the base portion (and the first and second ramp portions) pivot about the centreline in the downwards direction. The first and second sections of the base portion may be configured to deform in the downwards direction further than the first configuration such that the width of the longitudinal opening is wider than the first width. A lower angle between an external surface of the first and second sections of the base portion may be less than 180°when the conduit is deformed further than the first configuration.

Accordingly, the conduit having additional flexibility to deform beyond the first and second configurations improves the adaptability of the conduit by enabling the conduit to conform to surfaces which are not planar. For example, the conduit may be better able to conform to surfaces comprising slopes, ramps or steps thus increasing the stability of the conduit and reducing the likelihood of the conduit being a trip hazard.

The conduit may comprise a flexible material, the flexible material being configured to enable the deformation of the conduit about the centreline.

The flexible material may have a stiffness defined by a Young's modulus between 0.005-3 GPa, more preferably between 0.01 GPa and 1.8 GPa. Therefore, the conduit is able to deform between the first and second configurations under its own weight when it is placed on a surface and the likelihood of the conduit permanently deforming is reduces compared to if stiffer materials were uses.

The flexible material may be a flexible thermoplastic. In some examples, the flexible material may comprise flexible PVC (Polyvinyl Chloride). The flexible PVC may be UV resistant flexible PVC for increasing the durability of the conduit when it is being used outdoors. In other examples, the flexible material may comprise TPR (Thermoplastic Rubber) or TPE (Thermoplastic Elastomer).

The flexible material may be located between the first and second sections of the base portion for enabling the deformation of the base portion about the centreline. For example, the base portion may comprise a living hinge comprising the flexible material. In other examples, the entirety of the base portion may be formed from the flexible material.

In some examples, the cable conduit may be an integral conduit (i.e., the conduit may be integrally formed from one part). The conduit may be integrally formed from the flexible material. Therefore, the manufacturing complexity of the conduit may be reduced compared to existing conduits having multiple parts. For example, the conduit may be manufactured using injection moulding, extrusion, casting, additive manufacturing (printing), vacuum forming, or rotational moulding. Accordingly, the cable conduit of the first aspect may be relatively inexpensive to manufacture, thereby enabling affordable installations, and encouraging wider EV-adoption among owners of terraced houses.

In some examples the conduit may be flexible and configured to bend vertically or horizontally along its length between the first and second ends. Enabling the conduit to bend along its length increases the adaptability of the cable to different surfaces. For example, the conduit may be bent to conform with the shape of pavement surfaces which are not flat or planar. For example, the flexible conduit may be installed on a pavement which comprises a mound or a slope. The flexible conduit may follow the profile of the pavement surface thereby reducing the likelihood of the conduit being a trip hazard.

The conduit may comprise a hollow interior between the base portion and the first and second ramp portions. The hollow interior may comprise a first hollow section between the first section of the base portion and the first ramp portion and a second hollow section between the second section of the base portion and the second ramp portion. The first and second hollow sections may be separated by the cable containment channel. For example, the cable containment channel may be formed from an inner wall which extends from the first and second inner edges down to the base portion thereby dividing the hollow interior into the first and second hollow sections.

In some examples, the hollow interior (or the first and second hollow sections) may be divided into further hollow subsections. For example, the hollow interior may comprise reinforcing ribs, struts, or webs, as described below, which may divide the hollow interior into subsections.

By providing a hollow, or substantially, hollow interior the conduit may be lighter and more flexible than solid conduits. Therefore, the conduit may be more convenient to install and move around. Additionally, less material may be required to make the conduit therefore reducing the manufacturing complexity of the conduit and the time to manufacture the conduit. For example, if the conduit is manufactured using additive manufacturing such as 3D printing, then less material may need to be deposited in each layer when the conduit comprises a hollow interior.

As mentioned above, the conduit may comprise one or more reinforcing struts extending between the first section of the base portion and the first ramp portion. The conduit may comprise one or more reinforcing struts extending between the second section of the base portion and the second ramp portion. In some examples, the struts may be longitudinal ribs or dividers extending parallel to the longitudinal axis along the length of the conduit. The conduit may comprise a plurality of ribs thereby forming a reinforcing web within the interior of the conduit. The conduit may comprise a plurality of struts or ribs in each of the first and second hollow sections connected to the first section of the base portion and the first ramp portion, and to the second section of the base portion and the second ramp portion respectively. In some examples, some or all of the struts may be columns or tabs. Multiple columns or tabs may be provided as one or more rows of struts arranged parallel to the longitudinal axis. The presence of reinforcing struts may strengthen the conduit thus preventing the likelihood of the conduit from permanently deforming when objects or pedestrians move over the conduit.

Alternatively, in some examples the conduit may comprise a solid interior. This can be useful for provided a stronger conduit which is less likely to deform when heavy objects such as cars or HGVs (heavy goods vehicles) move over the conduit.

The cable containment channel may comprise a circular cross-section. However, in some examples the cross section of the cable containment channel may be other suitable shapes such as ovular, square of rectangle. In some examples, the cable containment channel may be configured to house a plurality of EV charging cables. The cable containment channel may extend along the longitudinal axis. The cable containment channel may be positioned symmetrically about the centreline of the cable conduit.

As mentioned above, the conduit may comprise one or more additional cable containment channels for receiving additional cables. The cable conduit and the one or more additional cable containment channels may be positioned parallel to each other along the longitudinal axis. In some examples, the conduit may comprise one or more cable containments channel configured to receive multiple cables. Accordingly, the cable conduit may be configured to protect more than one cable without requiring an additional conduit. This may be useful, for example, if a user wishes to charge two electric vehicles at the same time or two or more users (e.g., neighbours) wish to charge their vehicles at the same time.

The conduit may be configured to receive an EV charging cable having a diameter between 8 mm-20 mm, more preferably between 12 mm-16 mm. The conduit may also be suitable also for cables that are not associated with EV's, and for hose pipes.

The first width of the opening may be smaller than a diameter of an EV charging cable. By providing a narrower opening, it is possible to reduce the risk of damage to the EV charging cable and the risk of heeled shoes or other objects from penetrating the conduit when it is in the first configuration.

The first width of the longitudinal opening, when the conduit is in the first configuration, may be at least 5 mm, more preferably at least 8 mm, more preferably at least 10 mm. In this way, the conduit is easier to clean than conduits which close entirely. Moreover, a cable may be pulled out of the opening, part way along the conduit without requiring a lid to be opened and causing a trip hazard.

The first width of the longitudinal opening, when the conduit is in the first configuration, may be no more than 20 mm, more preferably no more than 15 mm, more preferably no more than 12 mm. Accordingly, the risk of heels, wheels or other objects from penetrating the conduit is reduced when the conduit is placed on the surface in the first configuration.

The first width of the longitudinal opening between the inner edges of the first and second ramp portions may between 6 mm-20 mm, more preferably between 8 mm-15 mm, more preferable 10 mm-12 mm, more preferably 11±0.3 mm when the conduit is in the first configuration.

The first ramp portion may comprise a first longitudinal inner lip extending over the cable containment channel. Therefore, in this example, the inner edge of the first ramp portion may be a distal (inner) edge of the first inner lip. The first inner lip may protrude from the first ramp portion towards the second ramp portion such that the first inner lip forms an upper surface of the first ramp portion (when the conduit is in the topside-up configuration).

The first inwardly extending lip may help to guide a cable into the inner cable containment channel thus making the conduit easier and more convenient to use. Additionally, the inwardly extending lip may help to protect the inner cable containment channel and act as a barrier for preventing objects such as heels, wheels, or debris from penetrating the channel.

The inwardly extending lip may be a ledge extending horizontally from the remainder of the first ramp portion when the conduit is in the first configuration. In this context, components extending horizontally may be considered as extending in a horizontal plane, the horizontal plane being a plane parallel to the base portion of the conduit.

The first inwardly extending lip may comprise a proximal connection edge connected to the remainder of the first ramp portion and a distal edge, the proximal and distal edges extending in the longitudinal direction. The inwardly extending lip may extend continuously along the entire length of the conduit in the longitudinal direction. Alternatively, the inwardly extending lip may comprise gaps or openings along the longitudinal direction.

The first inner lip (which may also be referred to as an inwardly extending lip) may comprise a flexible material such that the first inner lip is configured to deform when a cable is inserted through the longitudinal opening. In this way, the interior containment channel is more easily accessed, enabling more convenient installation and removal of cables. In some examples, the inwardly extending lip may be integrally formed with the remainder of conduit and the flexible material may be a same flexible material used to from the remainder of the cable conduit.

The second ramp portion may comprise a second longitudinal inner lip extending over the cable containment channel. The inner edge of the second ramp portion may therefore by an inner edge of the second inner lip, The second inner lip may comprise any of the optional features disclosed above in relation to the first inner lip. For example, the second inner lip may comprise a flexible material such that the second inner lip is configured to deform when a cable is inserted through the longitudinal opening

When the conduit comprises first and second inwardly extending lips, the width of the longitudinal opening may be defined as the distance between the inner (distal) edges of the inwardly extending lips. Therefore, when the conduit is in the first and second configurations, the distance between the inner edges of the first and second inner lips is the first width and second widths respectively, the first and second widths being non-zero.

In some examples, the first and second ramp portions may be symmetrical about the centreline and the first and second angles may be the same. Therefore, the shallow slope of the ramp portions is provided on both sides of the conduit irrespective of the orientation of the conduit or whether the conduit is in the first or second configurations.

Alternatively, the conduit may be asymmetrical about the centreline and the first and second angles may be different. When the first and second angles are different, a width of the conduit between the centreline and the first longitudinal edge of the base portion may be different to a width of the conduit between the centreline and the second longitudinal edge of the base portion (i.e., the conduit may have a shallow, wide side having the larger of the first and second angles and a steeper, narrow side having the smaller of the first and second angles). Such an asymmetrical conduit may usefully be positioned closer to walls or pavement edges whilst still proving a shallow slope on one side.

The first angle may be between 3-15 degrees, more preferably between 6-10 degrees, more preferably 8 degrees. The second angle may be between 3-15 degrees, more preferably between 6-10 degrees, more preferably 8 degrees. By providing a conduit with a shallower gradient, which is also therefore wider, than known surface conduits the likelihood of the conduit being a trip hazard is reduced. The present inventors have found that the first and second angles being between 6-10 degrees, more preferably 8 degrees, results in a conduit which is easy and convenient for wheelchair users and cyclists to move over without causing a significant obstacle.

A width of the conduit between the first and second longitudinal edges may be between 180 mm and 250 mm, more preferably 200 mm-230 mm, more preferably 210 mm-220 mm, more preferably 217±1.5 mm. Therefore, the conduit may have a height which is suitable for housing EV cables whilst still presenting a shallow incline and decline to users and objects moving over the surface.

A height of the conduit between the base portion and the inner edges of the first and second ramp portions may be between 12 mm-25 mm, more preferably 16 mm-20 mm, more preferably 18±0.5 mm.

When the conduit comprises a hollow interior, the base portion may have a wall thickness between 1 mm-10 mm, more preferably between 2 mm-5 mm, more preferably 2.5±mm. The first and second ramp portions may have a wall thickness between 1 mm-10 mm, more preferably between 2 mm-5 mm, more preferably 2.5±mm.

An outer surface of the base portion may comprise grooves and/or protrusions. The grooves and/or protrusions may be configured to for resist movement of the conduit along the surface when the conduit is in the topside-up configuration (i.e., second configuration). The grooves and/or protrusions may be configured to provide an anti-slip upper surface to help prevent pedestrians or objects from sliding on the first and second sections of the base portion when the conduit is in the base-up configuration (i.e., the second configuration). The base portion may comprise a corrugated outer surface. The corrugations of the corrugated outer surface may extend along the base portion parallel to the longitudinal axis. Therefore, the corrugations may resist movement of the conduit along the surface in a direction perpendicular to the longitudinal axis (when the conduit is on a surface in the topside-up configuration) or prevent objects sliding on the base portion in a direction perpendicular to the longitudinal axis (when the conduit is on a surface in the base-up configuration).

The first and/or second ramp portions may comprise protrusions or grooves. The protrusions or grooves may be configured to resist movement of the conduit along the surface (when the conduit is on a surface in the base-up configuration) or to provide an anti-slip upper surface (when the conduit is on a surface in the topside-up configuration). The first and/or second ramp portions may comprise a corrugated outer surface. The corrugations of the corrugated outer surface may extend along the first and/or second ramp portions in a direction parallel to the longitudinal axis.

Accordingly, the provision of one or more corrugated outer surfaces means that conduit may by more secure and less likely move along the surface. Moreover, it may be easier, more convenient, and safer for pedestrians, wheelchairs, cyclists etc to move over the conduit without sliding on the first and second ramp portions (or the first and second sections of the base portion when the conduit is inverted).

The conduit may comprise connection holes at the first or second ends. The connector holes may be configured to receive connector pins for joining additional conduits to the conduit. In some examples, the conduit may comprise one or more connector pins at the first or second ends. Therefore, multiple conduits may be joined together in a convenient and secure way to obtain a longer, composite conduit.

The base portion may comprise screw holes configured to receive screws therethrough. Therefore, the conduit may be secured to the surface (e.g., a pavement) to prevent it from moving or causing a trip hazard. Moreover, the screw holes can act as drainage holes for water to exit the conduit.

The conduit may have a uniform cross-section from a first end of the conduit to a second end of the conduit along the longitudinal axis. The conduit may extend in a straight line from the first end to the second end. However, in some examples the conduit may comprise bends or corners.

The conduit may have a length from a first end to a second end along the longitudinal axis of 30 mm-to 2000 mm. However, longer and shorter conduits may be possible. For example, as mentioned above, the conduit may be joined to a second conduit to form a longer conduit or the conduit may be cut to a shorter size in order accommodate different EV cable lengths, pavement widths, and/or a distance between the charging station and the charging point.

A second aspect of the invention may provide a kit comprising a plurality of the conduits of any preceding claim, the conduits being configured to be joined together to form a composite conduit. The kit may further comprise connector pins configured to connect the plurality of conduits together.

A third aspect of the invention may provide a method of installing a cable in the conduit of any preceding claim comprising: placing the conduit on a surface in the first configuration; and then inserting the cable into the cable containment channel through the longitudinal opening.

In the third aspect the conduit may be placed on the surface in a topside-up configuration wherein the base portion is proximal to the surface and the longitudinal opening is distal to the surface.

A fourth aspect of the invention may provide a method of installing a cable in the conduit of any preceding claim comprising: inserting the cable into the cable containment channel through the longitudinal opening, and then placing the conduit on a surface in the second configuration.

In the fourth aspect the conduit may be placed on the surface in a base-up (inverted) configuration wherein the longitudinal opening is proximal to the surface and the base portion is distal to the surface.

### SUMMARY OF THE FIGURES

Embodiments and experiments illustrating the principles of the invention will now be discussed with reference to the accompanying figures in which:

FIG. 1a shows a front view of a conduit for resting on a surface;

FIG. 1b shows a top view of the conduit of FIG. 1a;

FIG. 1c shows a bottom view of the conduit of FIG. 1a;

FIG. 1d shows a left-side view of the conduit of FIG. 1a;

FIG. 1e shows a perspective view of the conduit of FIG. 1a;

FIG. 1f shows another perspective view of the conduit of FIG. 1a;

FIG. 2a shows a conduit according to aspects of the present invention in the first configuration;

FIG. 2b shows the conduit of FIG. 2a in the second configuration;

FIG. 2c shows another view of the conduit of FIG. 2a in the first configuration;

FIG. 2d shows another view of the conduit of FIG. 2a in the second configuration;

FIG. 3 shows another front view of a conduit according to aspects of the present invention; and

FIGS. 4a-4c show an embodiment of the conduit including apertures for securing an attaching means.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

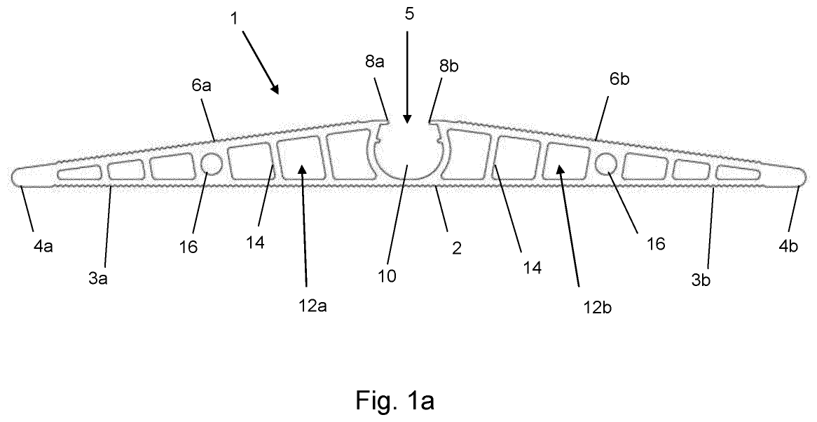

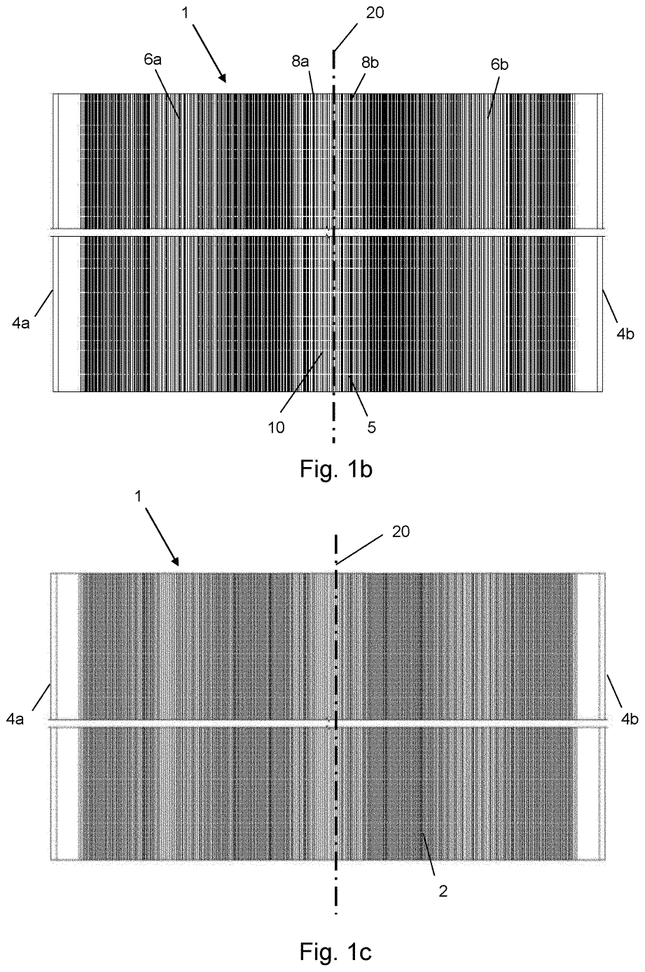

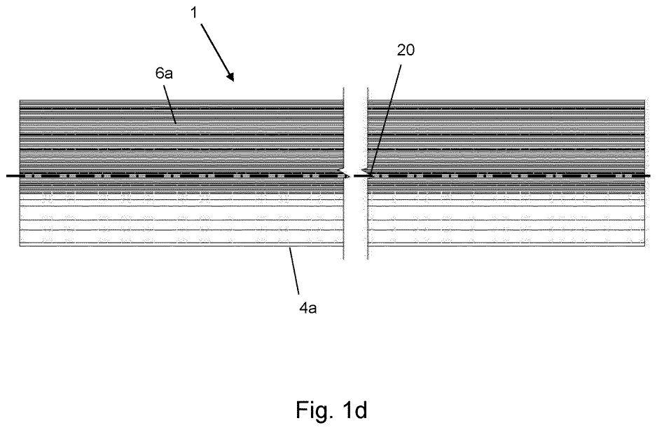

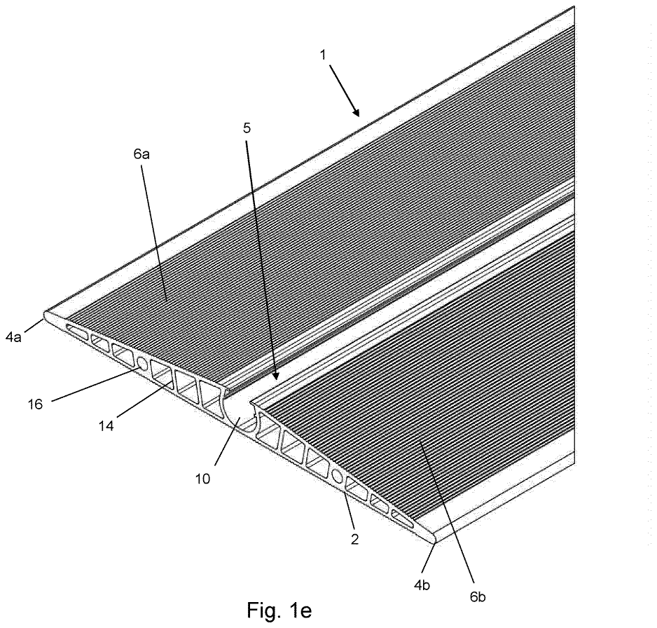

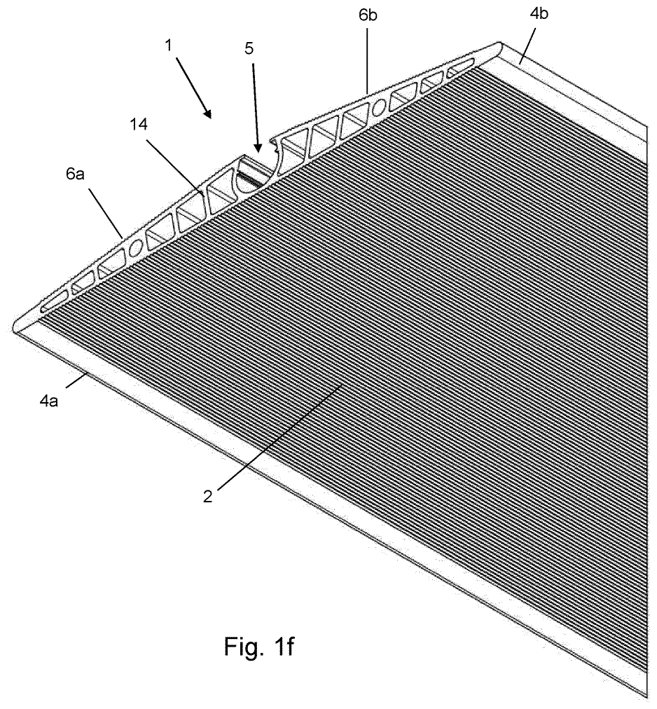

FIG. 1a shows a front view of a cable conduit 1 configured to rest upon a surface and house a cable according to the present invention.

FIGS. 1b-f show a side view, a top view, a bottom view, a perspective view and a second perspective view of the conduit 1, respectively.

The conduit 1 has a longitudinal axis defining a centreline 20 of the conduit 1. A cable containment channel 10 extending along the longitudinal axis 20 is provided for housing the cable. The conduit 1 is configured to accommodate, for example, an electric vehicle (EV) charging cable. For example, the conduit 1 may be configured to receive a cable having with a diameter between 11 mm and 20 mm. However, the conduit 1 may be configured to house other types of cables or hoses.

The centreline 20 extends from a first end of the conduit 1 to a second end of the conduit 1 parallel to the longitudinal axis. Therefore, in FIG. 1a the centreline extends into the page.

A base portion 2 extends between a first longitudinal edge 4a and a second longitudinal edge 4b of the conduit 1. The base portion 2 comprises a first planar section 3a extending between the first longitudinal edge 4a and the centreline 20, and a second planar section 3b extending between the second longitudinal edge 4b and the centreline 20. In this example, the outer surface of the base portion 2 is corrugated to prevent slippage of the conduit 1 along the surface.

A first ramp portion 6a extends from the first longitudinal edge 4a of the base portion 2 inwards and upwards (according to the perspective shown in FIG. 1a) towards the centreline 20 thereby defining a first angle between the first section 3a of the base portion 2 and the first ramp portion 6a. A second ramp portion 6b extends from the second longitudinal edge 4b of the base portion 2 inwards and upwards (according to the perspective shown in FIG. 1a) towards the centreline 20 thereby defining a second angle between the second section 6b of the base portion 2 and the second ramp portion 6b.

In this example, the first 6a and second 6b ramp portions, and therefore the first and second angles, are symmetrical about the centreline 20 of the conduit 1. The first 6a and second 6b ramp portions are substantially planar. In this example, the outer surfaces of the first 6a and second 6b ramp portions comprise corrugations.

The first angle and the second angles between the first 3a and second 3b sections of the base portion 2 and the ramp portions 6a, 6b are each less than 15 degrees. In the example shown, the first and second angles are 8 degrees. Therefore, the ramp portions 6a, 6b of the conduit 1 present shallower gradients to people and objects moving over the conduit 1 than typical surface cable conduits. Accordingly, the conduit 1 is less likely to impede pedestrians, wheelchair users, or cyclists etc.

The base portion 2 is configured to deform about the centreline 20. Therefore, the conduit 1 is invertible between a first configuration and a second configuration (the first and second configurations are discussed in detail below).

A first inner edge 8a of the first ramp portion 6b and a second inner edge 8b of the second ramp portion 6b are separated by a longitudinal opening 5. The longitudinal opening 5 extends along the centreline 20 thus exposing the cable containment channel 10.

In the example shown, the first 6a and second 6b ramp portions of the conduit 1 comprise first and second inwardly extending lips respectively. The inwardly extending lips are horizontal ledges extending along the longitudinal axis. The inwardly extending lips provide a partial cover over the cable containment channel 10, thus narrowing the longitudinal opening 5, to prevent debris or other objects from penetrating the conduit 1. When the ramp portions 6a, 6b comprise inwardly extending lips, the width of the longitudinal opening 5 may be measured between the inner edges of the first 8a and second 8b inwardly extending lips.

The inwardly extending lips 8a, 8b form a barrier over the cable containment channel 10 which helps to prevent dust, debris and objects such as heels and tyres from penetrating the conduit 1 when the conduit 1 is in the first configuration (discussed below). Therefore, the conduit 1 is safer for people moving over the surface and cables installed in the conduit 1 may be less likely to be damaged.

In this example, the conduit 1 comprises a hollow interior 12 between the first 6a and second 6b ramp portions and the base portion 2. In this example, the hollow interior comprises a first hollow section 12a between the first section 3a of the base portion 2 and the first ramp portion 6a and a second hollow section 12b between the second section 3b of the base portion 2 and the second ramp portion 6b. The first and second hollow sections are separated by the cable containment channel which extends between the longitudinal opening and the base portion.

In this example, the hollow interior 12 is further divided by reinforcing ribs 14 which connect an interior surface of the base portion 2 to interior surfaces of the ramp portions6a, 6b. The reinforcing ribs 14are longitudinal ribs which extend along the length of the conduit 1 parallel to the longitudinal axis. In other examples, reinforcing struts or pillars may be provided.

By providing a substantially hollow interior the conduit 1 is lighter and more flexible than solid conduits. Additionally, less material is required to make the conduit 1 therefore reducing the time, cost, and complexity involved in manufacturing the conduit 1.

The conduit 1 additionally comprises connection holes 16 at the first and/or second ends of the conduit 1. the connection holes 16 are configured to receive connector pins for joining the conduit 1 to a second conduit. Accordingly, a longer conduit may be constructed according to user preferences or needs.

In FIG. 1a the conduit 1 is shown in the first configuration wherein the first section 3a and the second section 3b of the base portion 2 are co-planar and the longitudinal opening 5 has a first width. In the first configuration the conduit 1 may be placed on a surface with the base portion 2 proximal to the surface and the longitudinal opening 5 distal to the surface (e.g., in the orientation shown in FIG. 1a). In this configuration, the longitudinal opening 5 may be considered as an upper opening and the first configuration may be considered as a “topside-up” configuration.

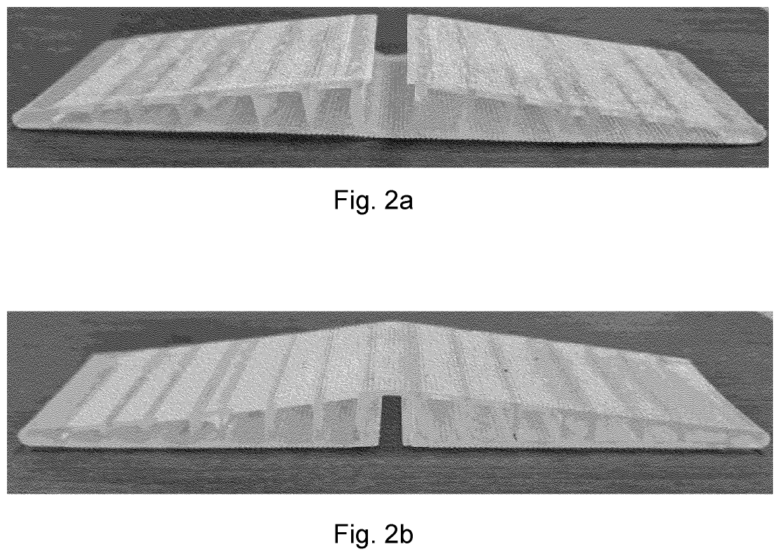

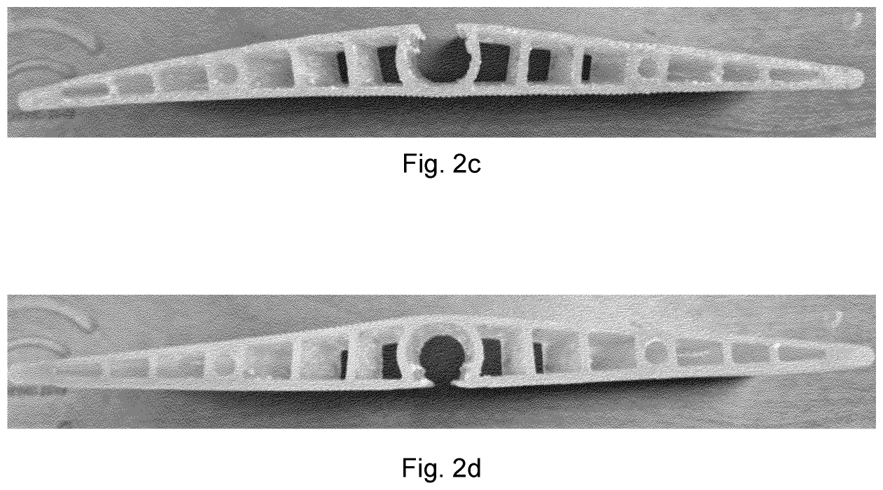

As mentioned above, the base portion 2 of the conduit 1 may be deformed (bent) along the centreline 20, such that the first 3a and second 3b sections of the base portion 2 and the first 6a and second 6b ramp portions pivot (i.e., fold) upwards (according to the perspective shown in FIG. 1a). The first 6a and second 6b ramp portions may pivot upwards until the conduit 1 reaches the second (inverted) configuration, as shown in FIG. 2b, wherein the first ramp portion 6a and the second ramp portion 6b are co-planar.

The pivoting of the ramp portions 6a, 6b causes the inner edges 8a, 8b of the first 6a and second 6b ramp portions to move towards each other and the longitudinal opening therefore narrows. Therefore, in the second configuration the longitudinal opening 5 has a second width which is narrower than the first width.

In the second configuration the conduit 1 may be placed on the surface with the longitudinal opening proximal 5 to the surface and the base portion 2 distal to the surface (as discussed below in relation to FIG. 2b). Therefore, the second configuration may also be considered as an “inverted” configuration or a “base-up” configuration.

FIG. 2a shows a picture of the conduit 1 in the first configuration resting on a surface. In this example, the surface is a planar surface. Therefore, the first 4a and second 4b sections of the base portion 2 are positioned flush with the surface.

In the first configuration, an EV cable may be inserted into the cable conduit 1 through the longitudinal opening 5. In order to fit the cable through the longitudinal opening 5 the inner edges of the conduit may deform. Specifically, the first 8a and second 8b inner lips can flex downwards under the pressure of a cable being pushed through the opening 5. The longitudinal opening 5 is thus widened enabling the cable to be installed in the cable containment channel 10.

The cable may also be pulled out of the conduit 1 via the longitudinal opening 10. The first 8a and second 8b inner lips may deform to allow the cable to pass therethrough. In some examples, a cable may be pulled partially out of the conduit 1 such that the cable protrudes from the longitudinal opening 5. This is useful in cases where an electric vehicle is parked partially over the conduit 1. In this example, the first 8a and second 8b inner lips may usefully grip the cable passing through the longitudinal opening 5.

FIG. 2b shows the conduit 1 of FIG. 2a in the second configuration wherein the first 6a and second 6b ramp portions are coplanar. In this example, the conduit 1 is placed on the surface in the base-up configuration wherein the longitudinal opening is proximal to the surface and the base portion is distal to the surface. Therefore, the first 3a and second 3b sections of the base portion 2 form additional ramp portions.

In the second configuration, a cable may be inserted into the cable conduit 1 through the longitudinal opening. In this configuration, the cable may be placed on the surface and the conduit 1 may then be placed over the top of the cable so that the cable is inserted into the cable containment channel 10 via the longitudinal opening 5 such that the cable is fully covered by the conduit 1.

As mentioned above, the first 8a and second 8b inner lips may be configured to flex outwards under the pressure of the cable being pushed through the longitudinal opening 5. The longitudinal opening 10 is thus widened enabling the cable to be installed in the cable containment channel 10.

Owing to the first 6a and second 6b ramp portions being planar in the second configuration, the conduit 1 is able to rest on the surface in the inverted configuration in a stable state without rocking motions. In this configuration, the corrugated outer surface of the base portion 2 acts as an anti-slip surface for pedestrians moving over the conduit 1. The corrugated outer surfaces of the first 6a and second 6b ramp portions provide an anti-slip surface with helps to resist slippage of the conduit 1 along the surface.

FIG. 2c shows another view of the conduit 1 of FIG. 2a in the first configuration. However, in FIG. 2c the conduit 1 is resting on an end of the conduit 1. Nevertheless, it is clear that the conduit 1 is in the first configuration because the first 3a and second 3b sections of the base portion 2 are coplanar.

FIG. 2d shows another view of the conduit 1 of FIG. 2a in the second configuration. Again, the FIG. 2d the conduit 1 is resting on an end of the conduit 1. Nevertheless, it is clear that the conduit 1 is in the second (inverted) configuration because the first 6a and second 6b ramp portions are coplanar and the first 3a and second 3b sections of the base portion 2 are not.

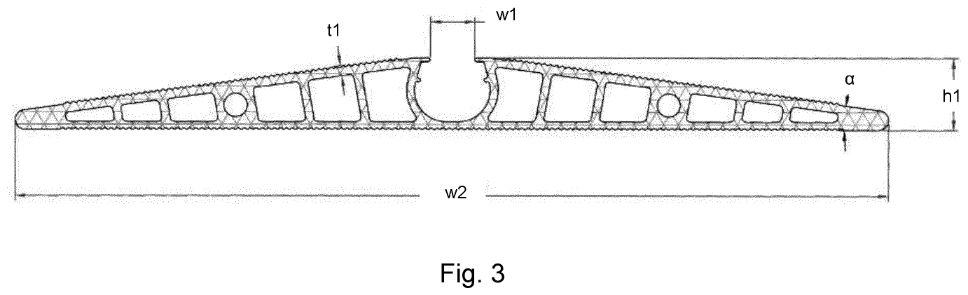

FIG. 3 shows another front view of a conduit 1 according to aspects of the present invention with example dimensions.

In FIG. 3, the width w1 of the opening between the inner edges of the inwardly extending lips (when the conduit 1 is in the first configuration) is 11 mm+/−0.3 mm. The width of the base portion w2 is 217 mm+/−1.5 mm. The nominal wall thickness t1 of the base portion and the first and second ramp portions is 2.5 mm+/−0.4 mm. The maximal height of the conduit 1 measured vertically from the base portion to the inner edges of the ramp portions is 18.0+/−0.5 mm. The angle a between the first section of the base portion and the first ramp portion is 8°. In this example, the angle between the second section of the base portion and the second ramp portion is also 8°.

The conduit 1 comprises a flexible material configured to enable the deformation of the conduit 1 about the centreline.

The material may be a flexible thermoplastic. For example, the flexible material may be a flexible thermoplastic. In some examples, the flexible material may comprise flexible PVC (Polyvinyl Chloride). The flexible PVC may be UV resistant flexible PVC for increasing the durability of the conduit 1 when it is being used outdoors.

The flexible material may be located between the first and second sections of the base portion for enabling the deformation of the base portion about the centreline. For example, the base portion 2 may comprise a living hinge comprising the flexible material. In other examples, the entirety of the base portion 2 may be formed from the flexible material.

However, in the examples shown, the entire conduit 1 is integrally formed from the flexible material. Therefore, the conduit 1 may be manufactured using injection moulding, extrusion, casting, additive manufacturing (printing), vacuum forming, or rotational moulding.

Accordingly, an above-surface cable conduit 1 is provided which has a shallower gradient than existing conduits and which is reversible between two different configurations thereby improving the adaptability of the conduit 1 to different applications.

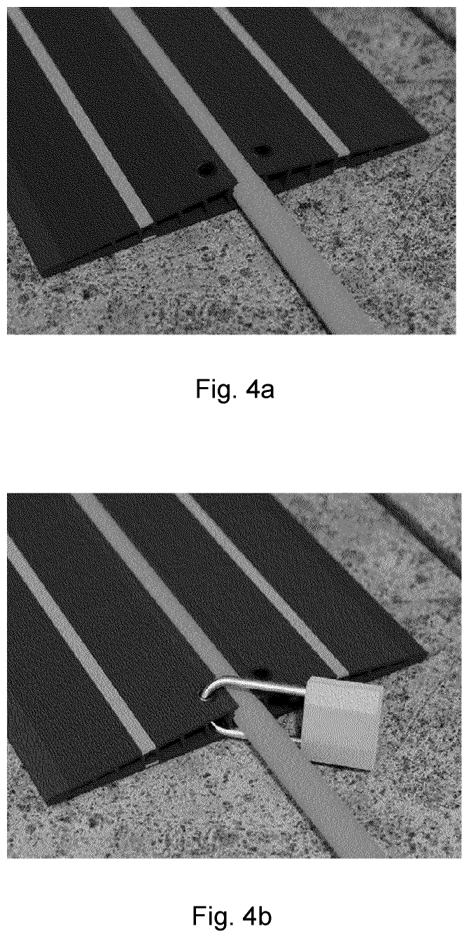

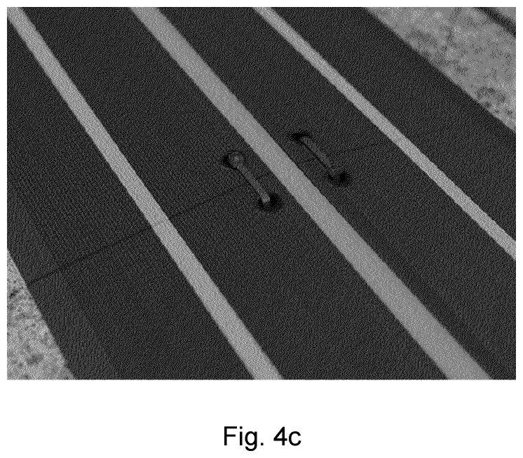

FIG. 4a shows an embodiment of the conduit which includes two apertures (which may be referred to as rivet holes) located in each of the first 6a and second 6b ramp portions, respectively. The apertures are located adjacent to the first 8a and second 8b inner lips so the apertures can receive a securing means such as a padlock or a cable tie which may optionally be fitted around a cable located in the conduit 1. Accordingly, the apertures are positioned closer to the first 8a and second 8b inner lips than the distal edges of the ramp portions 6a, 6b (where the ramp portions 6a, 6b meet the first 4a and second 4b base portions).

For example, FIG. 4b shows an example of the conduit of FIG. 4a including a padlock inserted through one of the apertures to help secure the cable to the conduit 1 and help prevent theft. An alternative securing means may also be used for this function such as a cable tie. In some examples, the conduit 1 may only comprise one aperture for this purpose.

Additionally, the apertures are located adjacent to one, or both, of the longitudinal ends of the conduit 1. This makes it easier to attach the securing means (e.g., a padlock or cable tie) to the apertures. Further, an attaching means, such as a cable tie, may be used to attach the conduit 1 to a second conduit 1 via the apertures, as shown in FIG. 4c, effectively extending the length of the conduit 1.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A cable conduit configured to rest upon a surface and house a cable, the conduit having a longitudinal axis defining a centerline of the conduit and a cable containment channel extending along the longitudinal axis for housing the cable, wherein the conduit comprises:
a base portion extending between a first longitudinal edge and a second longitudinal edge, the base portion comprising a first planar section extending between the first longitudinal edge and the centerline, and a second planar section extending between the second longitudinal edge and the centerline;
a first ramp portion extending from the first longitudinal edge of the base portion towards the centerline thereby defining a first angle between the first section of the base portion and the first ramp portion; and
a second ramp portion extending from the second longitudinal edge of the base portion towards the centerline thereby defining a second angle between the second section of the base portion and the second ramp portion;
wherein an inner edge of the first ramp portion and an inner edge of the second ramp portion are separated by a longitudinal opening, the longitudinal opening extending parallel to the centerline and exposing the cable containment channel;
wherein the first angle and the second angle are each less than 15 degrees, and the base portion is configured to deform about the centerline, such that the conduit is invertible between: a first configuration wherein the first section and the second section of the base portion are co-planar and the longitudinal opening has a first width, and a second configuration wherein the first ramp portion and the second ramp portion are co-planar and the longitudinal opening has a second width; wherein the second width is narrower than the first width.

2. The conduit of claim 1 wherein the conduit comprises a flexible material, the flexible material being configured to enable the deformation of the conduit about the centerline.

3. The conduit of claim 2 wherein the conduit is integrally formed from the flexible material.

4. The conduit of claim 2 wherein the flexible material has a Young's modulus between 0.01 GPa and 1.8 GPa.

5. The conduit of claim 2 wherein the flexible material is flexible PVC.

6. The conduit of claim 1 comprising a hollow interior between the base portion and the first and second ramp portions.

7. The conduit of claim 6 further comprising reinforcing struts extending between the first section of the base portion and the first ramp portion and between the second section of the base portion and the second ramp portion.

8. The conduit of claim 1 further comprising one or more additional cable containment channels.

9. The conduit of claim 1 wherein the first and second ramp portions are symmetrical about the centerline and the first and second angles are the same.

10. The conduit of claim 1 wherein the first and second angles are 8 degrees.

11. The conduit of claim 1 wherein a width of the conduit between the first and second longitudinal edges is between 180 mm and 250 mm.

12. The conduit of claim 1 wherein a height of the conduit is between the base portion and the inner edges of the first and second ramp portions is between 12 mm-25 mm.

13. The conduit of claim 1 wherein a width of the longitudinal opening between the inner edges of the first and second ramp portions is between 6 mm-20 mm when the conduit is in the first configuration.

14. The conduit of claim 1 wherein:
the first ramp portion comprises a first longitudinal inner lip extending over the cable containment channel;
wherein the inner edge of the first ramp portion is an inner edge of the first inner lip, and the first inner lip comprises a flexible material such that the first inner lip is configured to deform when a cable is inserted through the longitudinal opening.

15. The conduit of claim 14 wherein:
the second ramp portion comprises a second longitudinal inner lip extending over the cable containment channel;
wherein the respective inner edge of the second ramp portion is an inner edge of the second inner lip; and the second inner lip comprises a flexible material such that the second inner lip is configured to deform when a cable is inserted through the longitudinal opening

16. The conduit of claim 1 wherein the base portion comprises a corrugated outer surface.

17. The conduit of claim 1 wherein the first and second ramp portions comprise corrugated outer surfaces.

18. The conduit of claim 1 comprising connector pins for joining additional conduits thereto.

19. The conduit of claim 1 wherein the conduit comprises a plurality of conduits each configured in accordance with the conduit of claim 1, the conduits further being configured to be joined together to form a composite conduit.

20. (canceled)

21. (canceled)
